(19) United States
(12) Patent Application Publication
(10) Pub. No.: US 2003/0037260 A1
(43) Pub. Date: Feb. 20, 2003

(54) Heuristic profiler for packet screening

(76) Inventor: Gary Milo, Ascot (GB)

Correspondence Address: BROMBERG & SUNSTEIN LLP, 125 SUMMER STREET, BOSTON, MA, 02110-1618, US

(21) Appl. No.: 10/029,088

(22) Filed: Oct. 19, 2001

Related U.S. Application Data
(60) Provisional application No. 60/313,577, filed on Aug. 16, 2001.

(51) Int. Cl. G06F 11/30

(52) U.S. Cl. 713/201

(57) ABSTRACT

An apparatus and method for screening packets at an interface between a local site and an external network. A heuristic profiler ascribes a hierarchical value to each address on the external network based at least on prior activity associated with the address and a filter selectively passes packets from the external network to the site on the basis, at least, of the hierarchical value ascribed to the source address associated with each packet.

The present application claims priority from U.S. Provisional Application Serial No. 60/313,577, filed Aug. 16, 2001, and incorporated herein by reference.

### FIELD OF THE INVENTION

The present application is directed to an apparatus and to methods for screening the flow of data packets between a local site and an external network to which it is connected.

### BACKGROUND OF THE INVENTION

Distributed denial of service (DDoS) attacks have repeatedly demonstrated the capacity, by deluging a targeted website with malicious traffic from multiple points on the Web, to tie up network bandwidth and to block legitimate traffic to the targeted site. In a typical DDoS attack, an agent module is installed in multiple computers and, at the instigation of a controlling computer, each agent is prompted to send bogus data packets, such as requests for the download of data, to the target website. A denial of service attack may thus threaten to overload the target's capacity. Without effective protection, a site connected to a public network may thus be subject to malicious attack by parties having access to it via the public network.

Countermeasures to date have been ineffective in dealing with increasingly sophisticated DDoS attacks. The results of a 1999 CERT-sponsored workshop on proposed responses to DDoS attacks are appended hereto and incorporated herein by reference.

The preferred defense measure available to a user is currently the placement of filters of various sorts, typically by internet service providers. Techniques currently employed to combat DDoS attacks include the following:

a. Routers that filter packets on the basis of IP address, protocol and port have been employed in an attempt to mitigate DDoS attacks. This technique depends on the use of preset filter tables to select packets for transmittal or rejection. Updating the filter tables in real-time to follow changing attack patterns has proved difficult.

b. Firewalls that filter on IP address, protocol and port have also been employed to defend against these attacks. As in the case of routers, filter rules must be updated in real-time to follow changing attack patterns; human intervention and a high level of expertise is needed to operate these firewalls effectively.

c. Bandwidth shapers have also been employed to deal with DDoS attacks. Such shapers limit traffic by protocol, port and IP address. This technique has met with limited success because it is difficult to adjust these limitations to follow changing attack patterns and, further, these shapers do not differentiate among the types of traffic, and may stop normal communication attempts as well as attacking traffic.

### SUMMARY OF THE INVENTION

In accordance with preferred embodiments of the present invention, an interface is provided between a local site and an external network. As used herein and in any appended claims, the term “site” refers to a device, connected to an external network, that both receives and sends information over the network. The term “external network” refers to a plurality of interconnected sites, and may include, without limitation, the Internet, telephone networks, optical networks, fiber or wireless, microwave or radio networks, packet-based radio telephones, Next Generation Internet (NGI), Internet 2, etc. The salient characteristics of an “external network” for purposes of the present application are:

a. that the proprietor of the local site does not have control over content placed over the network by other parties, each of whom is characterized, at least at any given instant, by an address; and

b. that data is conveyed on the external network in the form of packets, in accordance with a prescribed protocol.

The interface that is provided, in accordance with preferred embodiments of the invention, has a heuristic profiler for ascribing a characterizing value to each address on the external network and a filter for selectively passing packets from the external network to the site based at least on the characterizing value ascribed to the address associated with each packet.

The interface, in accordance with further embodiments of the invention, has a computer program product with associated software programs that screen all packets entering and leaving a protected site from/to a public network. The interface both screens and profiles packets exchanged between one or more of the protected site's computers and a source node on the public network. Screening is conducted on the basis of several threshold criteria.

Additionally, profiling of the packets keys on the source node's internet protocol (“IP”) address and associates a value, referred to as “charm”, with each source node based on one or more characteristic parameters, including recent network interactions with the protected site's computers.

The charm value for a source node increases, for example, as “proper” packet exchanges accrue between the source and the protected site's computers and decays with the passage of time.

Under conditions of DDoS attack, the interface begins filtering packets based, at least in part, on a charm value threshold; packets with higher charm values are preferentially passed to the protected site's computers while other packets are discarded. The threshold for preferential treatment may vary based on node activity relative to pipeline capacity. The charm calculation automatically and dynamically takes into account the characteristics of normal packet traffic exchanged between computers on the protected site and nodes on the public network.

### BRIEF DESCRIPTION OF THE DRAWINGS

The foregoing features of the invention will be more readily understood by reference to the following detailed description taken with the accompanying drawings in which:

FIG. 1 is a schematic view showing the interposition of a WebScreen™ filter between a local site and a connection to an external network in accordance with preferred embodiments of the present invention;

FIG. 2 is a flow chart of packet processing, in accordance with preferred embodiments of the present invention;

FIG. 3 is a flow chart showing steps in the characterization of network addresses in accordance with embodiments of the present invention; and

FIG. 4 is a further flow chart showing additional features of packet processing, in accordance with further embodiments of the present invention.

### DESCRIPTION OF PREFERRED EMBODIMENTS

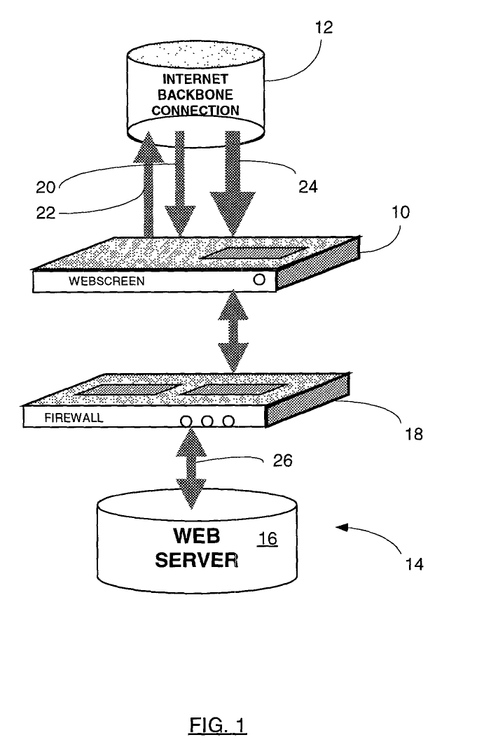

Referring first to FIG. 1, a profiler 10 is provided, in accordance with preferred embodiments of the present invention, for screening the flow of data packets across a network interface. As used herein, and in any appended claims, the term “interface” is used in the context of a data network to refer to a point at which a selection is made as to recipients and/or sources of data. Thus, an interface is typically a point characterized by a change in data-carrying capacity, or bandwidth, of the network. One typical interface at which the present application is advantageously deployed is the interface, depicted in FIG. 1, between a connection to an external network such as the Internet backbone 12 and a local site 14 which may be any device but is represented, for purposes of example, by a web server 16. Local site 14 may, of course, comprise one or more computers or peripheral devices, a local network, and one or more web servers.

A conventional firewall 18 may be interposed between web server 16 and the Internet backbone connection 12 for standard security purposes such as preventing infiltration of the local site or other non-DDoS attacks. Where a firewall 18 is employed, profiler 10 is preferably interposed on the side of the firewall facing the external network 12.

Profiler 10 examines the entirety of packet traffic, both in-bound 20 and out-bound 22, as generated locally, flowing on the external network at node 12. Connection is performed using standard Peripheral Component Interconnect (PCI) and Network Interconnect (NIC) protocols so as to operate on incoming traffic 20 without being accessible from external sites. The profiler 10 itself has no Internet Protocol (IP) address, nor does it perform IP protocol functions such as handshakes but is, instead, transparent to ordinary data traffic between the external network and the local site. A DDoS attack, with a large volume of requests directed at local site 14, is represented in FIG. 1 by arrow 24. It is a function of profiler 10 to protect local site 14 from the effects of attack 24.

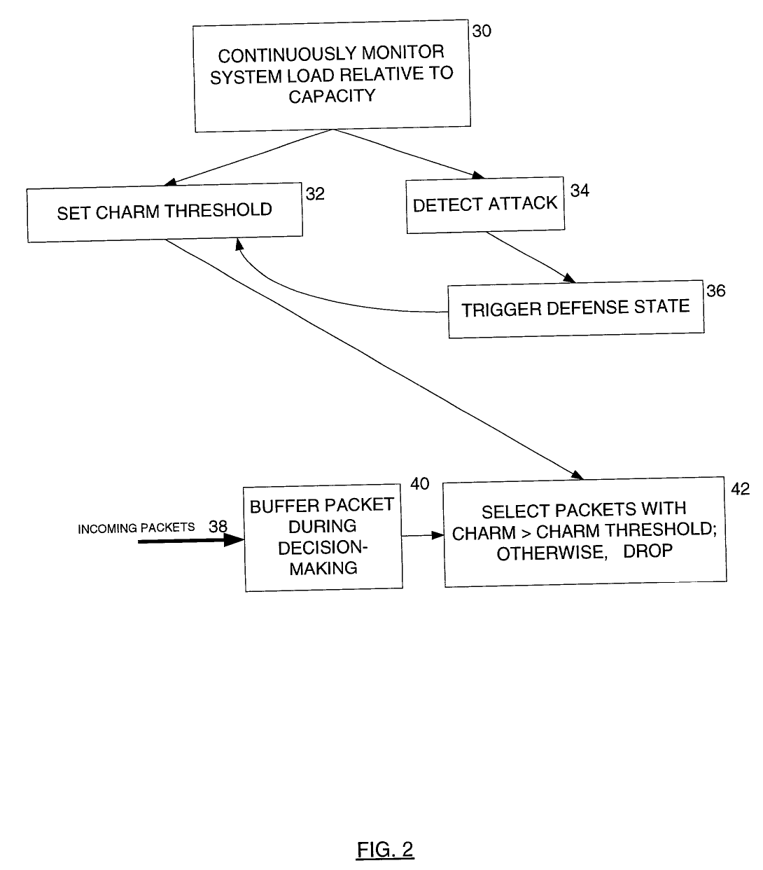

Functional operation of the profiler 10 is now described with reference to the flowchart of FIG. 2. The load on the local system 14 is constantly monitored by profiler 10, as designated by box 30. Load may be monitored in any of a number of ways, including the monitoring of data flow 26 into, and out of, the local system relative to known bandwidth limitations. Additionally, the load on the processor or processors in response to traffic 20, 22 may be monitored.

Based on the load evaluated in step 30, a threshold value is set, in step 32, against which incoming packets will be measured, as further discussed below. The threshold measure against which incoming packets will be measured is referred to herein as “charm.” When the charm threshold has a value of zero (0), incoming packets are allowed to pass unencumbered to the local site 14. Measurement of load additionally takes into account the flow 22 of data from local site 14 to external network 12. Thus, for example, if a small number of requests results in server 16 providing a large number of pages, as may occur, for example, if the requesting source is a machine programmed maliciously to overwhelm the capacity of server 16, then the resultant load on the system is accounted for.

The profiling interface, using criteria discussed below, detects, in step 34, the presence of a denial-of-service attack. Upon detection of an attack, a Defense State 36 is triggered. In the Defense State, the charm threshold is reevaluated and raised, so that fewer incoming packets are selected, thereby preserving the system load at, or below, a specified Threshold Level relative to capacity. The Threshold Level may be preconfigured or specified by the user, and is preferably initially in the vicinity of 70% of full channel capacity, with additional defensive measures triggered at 80% and 90% of capacity.

Incoming packets from the network are received 38 and buffered 40 while they are selected 42 on the basis of the associated quality of their source address relative to the currently prevalent Charm Threshold, on the basis of criteria to be discussed below. Selected packets are allowed to pass through to the protected site, while packets that do not survive the selection process are dumped.

Two issues raised with respect to the flow chart of FIG. 2 are now addressed seriatim: how a Defense State is triggered in accordance with the invention, and how selection is made of a specified packet with respect to a currently active Charm Threshold level.

A Defense State may be triggered, for example, by one or more of the following conditions. If either input pipe 20 or output pipe 22, shown in FIG. 1, nears their respective capacities, based on a preset Trigger Threshold, a Defense State is entered. Thus, for example, pageflooding attacks may advantageously be detected. Additionally, the presence of classical attack formats such as SYN and ACK flooding, as well as PING, and LAND attacks may be detected and may trigger a Defense State. Packet headers may be inspected for trapping so-called “Xmas Tree Scans” performed in order to identify operating-system-specific, or hardware-specific, responses to malicious attacks. Furthermore, a check is preferably made for a threshold number of backlogged registers. Finally, a Defense State may also be entered manually by action of the system operator invoking a Global Defend Mode based on information otherwise available.

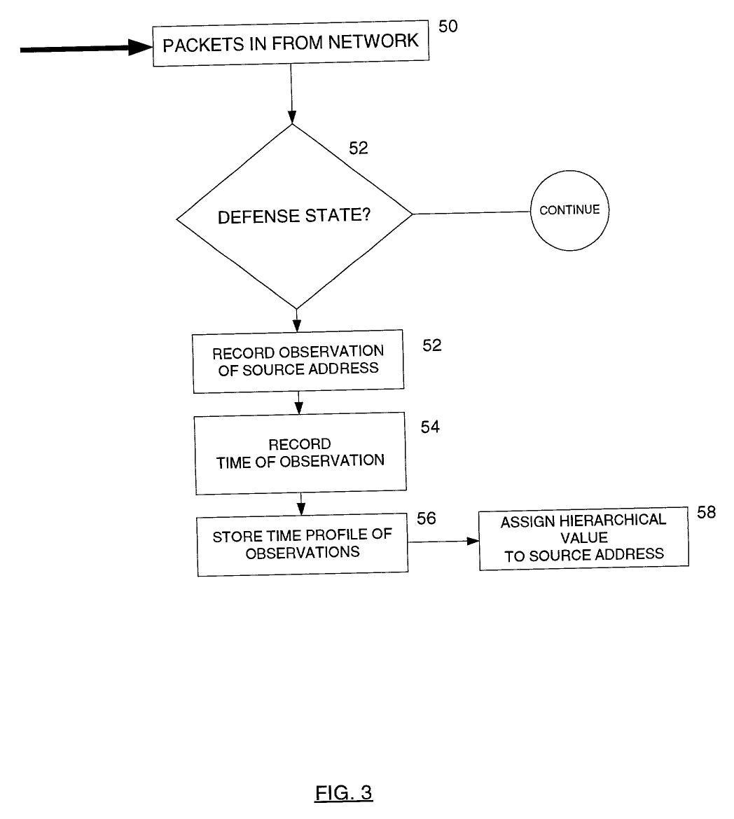

Referring now to FIG. 3, selection of packets is facilitated by a History Module, in accordance with preferred embodiments of the present invention, on the basis of associating a hierarchical value with each source address on the network from which the protected site has received a transmission. The action of History Module is illustrated in FIG. 3. In step 50, packets are received from the network. If the system is currently in a Defense State, then the recording of data by the History Module is frozen. Otherwise, in step 52, the observation of a source address is recorded by the system, with note being taken of known proxies and caches. In step 54, the time of the observation is recorded, thereby developing a time profile of observations, designated as 56. Certain behaviors lend assurance that a particular source address is benign, while other behaviors suggest malicious proclivities. Routine requests, for example, for reasonable quantifies of information allow a particular address to be assigned a higher quality factor in accordance with the aforesaid heuristic procedure. Packets associated with addresses that build up a high level of assurance, or “charm,” are thus given priority with respect to transmission from the network to the local site in cases where entry of the system into a Defense Mode has caused a heightened Charm Threshold, as discussed above.

Additionally, the History Module may also record data associated with statistical counts based on packets transmitted from the local site to the external network in conjunction with requests received from particular network source addresses. The History Module may also perform internal consistency checks on the basis of internally generated simulations of packets exhibiting designated temporal patterns of behavior.

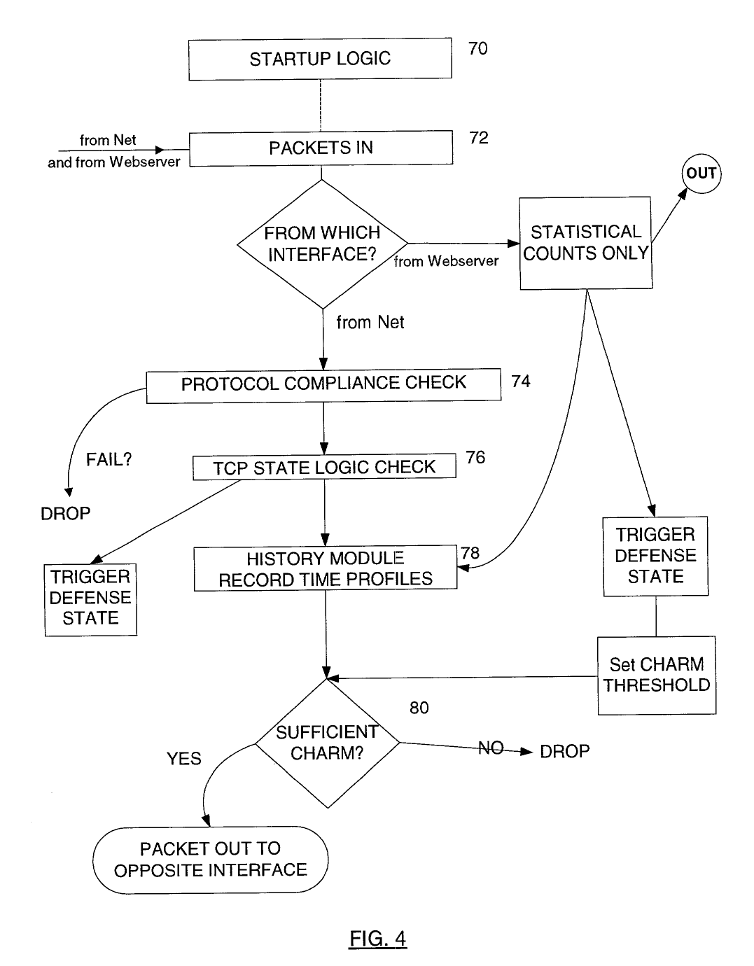

Several additional features of embodiments of the present invention are now described with reference to the flowchart of FIG. 4.

First, Startup Logic Module 70 provides for initialization of the interface for the specific environment in which the site is coupled to the network, accounting for such parameters as input and output channel bandwidths, traffic capacities of each server at the local site, desired operational modes, classical filtering parameters, etc.

Packets are received by the interface device, in accordance with embodiments of the invention, from both the local site and the external network, as indicated at step 72. In the case of outward-bound packets, only statistical counts are performed, whereas, for incoming packets, a Protocol Compliance Check 74 is first performed to exclude malformed packets from entry into the protected site. Simple firewall-type checks are performed at this stage, such as checks for connection types, etc. TCP State Logic Checking 76 detects SYN and ACK flooding as well as backlogged registers, thereby allowing triggering of a Defense Mode, as described above.

If the incoming packet is of sufficient quality and is associated with a network address of adequate pedigree to meet currently prevailing Charm Threshold standards, then the packet is passed on to the local site, and, otherwise, dropped. Bandwidth limiting is thus advantageously achieved based on dynamic requirements and a heuristic assessment of the quality of each incoming packet.

For the purpose of illustrating the invention, various exemplary embodiments have been described with reference to the appended drawings, it being understood, however, that this invention is not limited to the precise arrangements shown. For example, while the invention has been described, in the foregoing, in the context of deployment at the interface between an end-customer and a network, the techniques taught herein may also be advantageously employed, within the scope of the present invention, at a provider of network services, i.e., an Internet Service Provider (ISP), or, further, at interfaces between ISPs or other networks.

Indeed, numerous variations and modifications will be apparent to those skilled in the art. All such variations and modifications are intended to be within the scope of the present invention.

I claim:

1. An interface between a site and an external network for screening packets on the external network, each packet having an associated source address, the interface comprising:
a. an heuristic profiler for ascribing a characteristic value to each address on the external network based at least on prior activity associated with the address; and
b. a filter for selectively passing a particular packet from the external network to the site based at least on the characterizing value ascribed by the heuristic profiler to the source address associated with the particular packet.

2. An interface in accordance with claim 1, wherein the heuristic profiler ascribes a characteristic value to each known address on the external network based at least on characteristics of prior packets received by the site bearing the source address associated with the particular packet.

3. An interface in accordance with claim 1, wherein the site is a computer.

4. An interface in accordance with claim 1, wherein the site is a local network of computers.

5. An interface in accordance with claim 1, wherein the site is a web server.

6. The interface of claim 1, further comprising a firewall in communication with the site, the firewall interposed between the site and the network.

7. The interface of claim 1, further comprising a load monitor for monitoring the traffic of packets between the network and the site relative to a specified nominal load.

8. The interface of claim 7, wherein the filter selectively passes a particular packet based at least on the monitored traffic of packets.

9. The interface of claim 1, further comprising a history module for developing a time profile of observations of packets received from associated source addresses.

10. A method for screening a flow of packets between a site and an external network, each packet having an associated source address, the interface comprising:
a. ascribing a hierarchical value to a subset of addresses on the external network based at least on prior activity associated with each address of the subset; and
b. selectively passing packets from the external network to the site based at least on the hierarchical value ascribed to the source address associated with each packet.

11. A method according to claim 10, further comprising checking each packet for compliance with specified protocol standards.

12. A method according to claim 10, further comprising developing a time profile of observations of packets received from associated source addresses.

13. A method according to claim 10, further comprising the step of monitoring the traffic of packets between the network and the site relative to a specified nominal load.

14. A method according to claim 13, further including the step of setting a threshold standard based on the monitored traffic of packets between the network and the site.

15. A method according to claim 14, wherein the step of selectively passing packets from the external network to the site is based, at least in part, on the hierarchical value ascribed to the source address associated with each packet relative to the threshold standard.

16. A method for characterizing a subset of a universe of network addresses, each address corresponding to an associated device, the method based at least on observation of a transmission from each associated device, the method comprising:
a. recording occurrence of an observation;
b. recording a time associated with the observation;
c. retaining a timed profile of observations of transmissions from each associated device; and
d. using the timed profile to assign a hierarchical value to each network address of the subset.

17. A computer program product for use on a computer system for screening data flow between an external network device and a local site, the computer program product comprising a computer usable medium having computer readable program code thereon, the computer readable program code comprising:
a. program code for ascribing a hierarchical value to a subset of addresses on the external network based at least on prior activity associated with each address of the subset; and
b. program code for selectively passing packets from the external network to the local site based at least on the hierarchical value ascribed to the source address associated with each packet.
